(19) United States
(12) Patent Application Publication
(10) Pub. No.: US 2017/0110694 A1
(43) Pub. Date: Apr. 20, 2017

(54) LITHIUM-ION BATTERY FLEXIBLE PACKAGING MATERIAL AND LITHIUM-ION BATTERY USING THE SAME

(71) Applicant: Amperex Technology Limited, Ningde (CN)

(72) Inventors: Kefei WANG, Ningde (CN); Jibin GENG, Ningde (CN)

(73) Assignee: Amperex Technology Limited, Ningde (CN)

(21) Appl. No.: 15/012,075

(22) Filed: Feb. 1, 2016

(30) Foreign Application Priority Data
Oct. 19, 2015 (CN) 201510680032.5

(51) Int. Cl. H01M 2/02; H01M 10/0525

(52) U.S. Cl. CPC H01M 2/0275; H01M 10/0525; H01M 2/0287

(57) ABSTRACT

The present disclosure is related to the field of energy storage devices, and particularly a lithium-ion battery flexible packaging material and a lithium-ion battery using the same. The flexible packaging material comprises a substrate layer, a first bonding layer, a metal foil layer, an anti-corrosion treatment layer, a second bonding layer and a sealing layer arranged in sequence from the outside to the inside, wherein the anti-corrosion treatment layer is composed of at least one of a nickel layer, a nickel alloy layer, a copper layer and a copper alloy layer, and is plated on the metal foil layer. The lithium ion battery comprises a naked cell, an electrolyte and a packaging bag, wherein the packaging bag packages the naked cell and the electrolyte and is made of the lithium-ion battery flexible packing material. In the present disclosure, through applying the flexible packaging material plated with the anti-corrosion treatment layer to the lithium-ion battery, the resistance to hydrofluoric acid is apparently improved, the lithium alloy is hardly formed, and no lithium precipitation occurs even if a short-circuit occurs to the anode and packaging material, so the lithium-ion battery is capable of better resisting electrochemical corrosion, strengthening the safety and prolonging the service life of the lithium-ion battery.

### FIELD OF THE INVENTION

The present disclosure is related to the field of energy storage devices, and particularly a lithium-ion battery flexible packaging material and a lithium-ion battery using the same.

### BACKGROUND OF THE INVENTION

In related techniques, the aluminum compound packing film, which is basically composed of a polypropylene film inside, an aluminum metal foil layer in the middle and a nylon protective layer outside, is normally used as a lithium-ion battery flexible packaging material. When the cell is packaged for the lithium-ion battery, rags or active material particulates may remain on the periphery of the cell, which are capable of piercing through the inner layer to the metal foil layer in the bleeding air process. During package process of the cell, the breakage of the inner layer of the aluminum compound packing film caused by the mechanical actions or superfusion during heat sealing results in direct contact of the metal foil layer with the electrolyte, and the hydrofluoric acid in trace amount existing in the electrolyte causes the tubercular corrosion by contacting with the aluminum layer, so the function of obstructing the water vapor and air is out of action and thereby non-operation of the lithium-ion battery such as tympanites or leakage occurs. Meanwhile, through the potential difference between the anode and the aluminum metal foil layer, the lithium ion is inserted into the aluminum metal foil layer through the damaged inner layer to form aluminum-lithium alloy which performs electrochemical corrosion to the aluminum metal foil layer, thereby accelerating the corrosion of the aluminum metal foil layer.

The patent CN 101992570A discloses that the plastic aluminum compound film of a/an polyamide film/thermosetting cementing layer/aluminum foil/thermosetting cementing layer/unsaturated anhydride modified polypropylene film possesses good water vapor barrier, anti-explosion and heat-sealing cohesiveness properties, but has no significant effects against electrochemical corrosion. The patent CN102324557 improves the resistance to electrochemical corrosion through transparently shelled lithium-ion battery plated with the inorganic oxide-polymer film, but the problem is not substantially solved, though the polymer plated film is able to mitigate the corrosion effect to some extent; particularly when the energy density of the lithium-ion battery is higher and the packaging bag to be used becomes thinner, the corrosion problem becomes more serious. In view of this, it is essential to provide a packaging material having better resistance to electrochemical corrosion.

### SUMMARY

The present disclosure provides a lithium-ion battery flexible packaging material and a lithium-ion battery using the same, which is capable of improving the resistance to electrochemical corrosion.

According to a first aspect of the present disclosure, there is provided a lithium-ion battery flexible packaging material, comprising a substrate layer, a first bonding layer, a metal foil layer, an anti-corrosion treatment layer, a second bonding layer and a sealing layer arranged in sequence from the outside to the inside; wherein the anti-corrosion treatment layer is composed of at least one of a nickel layer, a nickel alloy layer, a copper layer and a copper alloy layer, and is plated on the metal foil layer.

Preferably, the anti-corrosion treatment layer is structured with multiple layers, material of each layer being the same or different.

Preferably, the thickness of the anti-corrosion treatment layer does not exceed 50% of the thickness of the metal foil layer.

Preferably, the sum of the thickness of the anti-corrosion treatment layer and the thickness of the metal foil layer is no less than 20 μm.

Preferably, the material of the sealing layer is polyethylene terephthalate, polyvinyl chloride, polyethylene or polypropylene, and the thickness of the sealing layer is no less than 20 μm.

Preferably, a decorative layer is provided on the outer side of the substrate layer.

Preferably, the material of the nickel alloy layer is nickel-copper alloy, nickel-boron alloy, nickel-magnesium alloy, nickel-aluminum alloy, nickel-titanium alloy, nickel-vanadium alloy, nickel-iron alloy, nickel-manganese alloy, nickel-cobalt alloy, nickel-zinc alloy, nickel-silver alloy or nickel-tin alloy; and/or

the material of the copper alloy layer is copper-nickel alloy, copper-boron alloy, copper-magnesium alloy, copper-aluminum alloy, copper-titanium alloy, copper-vanadium alloy, copper-iron alloy, copper-manganese alloy, copper-cobalt alloy, copper-zinc alloy, copper-silver alloy or copper-tin alloy.

Preferably, the metal foil layer is a stainless steel metal foil layer.

According to a second aspect of the present disclosure, there is provided a lithium-ion battery comprising a naked cell, an electrolyte, and a packaging bag, wherein the packaging bag packages the naked cell and the electrolyte, and wherein the packaging bag is made of the lithium-ion battery flexible packaging material.

Preferably, the difference between the dimension of the packaging bag in the length direction and the dimension of the naked cell in the same direction is no more than 5 mm; and/or

the difference between the dimension of the packaging bag in the width direction and the dimension of the naked cell in the same direction is no more than 5 mm.

The technical solution provided by the present disclosure achieves the following advantageous effects:

In the present disclosure, through applying the flexible packaging material plated with the anti-corrosion treatment layer to the lithium-ion battery, the resistance to hydrofluoric acid is apparently improved, the lithium alloy is merely formed, and no lithium precipitation occurs even if the short-circuit occurs to the anode and packaging materials, so the lithium-ion battery is capable of better resisting electrochemical corrosion and strengthening the safety in use and the life service of lithium-ion battery

It is to be understood that both the foregoing general description and the following detailed description are exemplary and explanatory only and are not restrictive of the invention, as claimed.

### BRIEF DESCRIPTION OF THE DRAWINGS

FIG. 1 is a structural view of the lithium-ion battery flexible packaging material without a decorative layer provided in an embodiment of the present disclosure;

FIG. 2 is a structural view of the lithium-ion battery flexible packaging material with a decorative layer provided in an embodiment of the present disclosure;

FIG. 3 is an inner structure view of the lithium-ion battery provided in another embodiment of the present disclosure;

### DRAWING EXPLANATION

1—packging bag;
10—substrate layer;
11—first bonding layer;
12—metal foil layer;
13—anti-corrosion treatment layer;
14—second bonding layer;
15—sealing layer;
16—decorative layer;
2—naked cell.

The accompanying drawings, which are incorporated in and constitute a part of this specification, illustrate embodiments consistent with the invention and, together with the description, serve to explain the principles of the invention.

### DETAILED DESCRIPTION

Reference will now be made in detail to exemplary embodiments, examples of which are illustrated in the accompanying drawings. The expressions “front”, “back”, “left”, “right”, “upper” and “lower” in the text take the disposition status of the lithium-ion battery flexible packaging material and the lithium-ion battery using the same in the drawings as references.

As illustrated in FIG. 1, Embodiment one of the present disclosure provides a lithium-ion battery flexible packaging material, which comprises a substrate layer 10, a first bonding layer 11, a metal foil layer 12, an anti-corrosion treatment layer 13, a second bonding layer 14 and a sealing layer 15 from outside to inside in sequence.

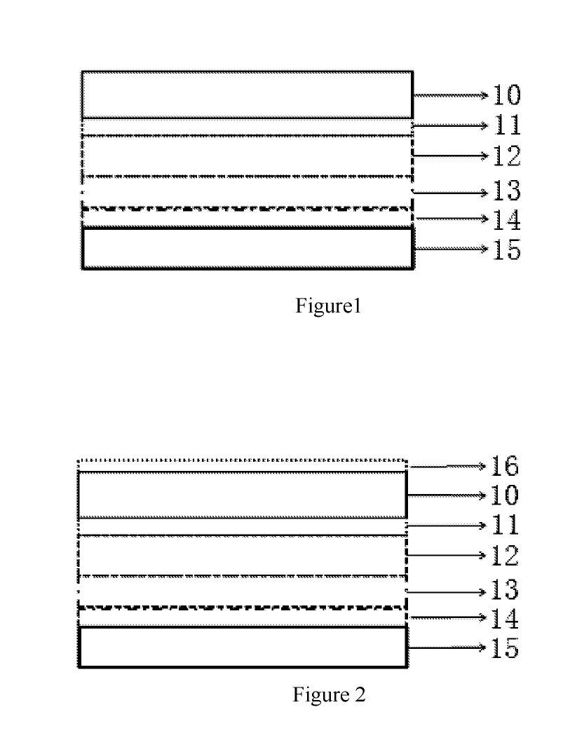

The substrate layer 10 disposed at the outer side of the packaging material for outside protection is composed of single layer or multiple layers of heat-resistant resin films, which serves as a cover material to be suitably cold-formed and may be selected from the stretched or non-stretched films of polyamide resin or polyester resin. Further, a decorative layer 16 such as matte layer or dyeing coating may be disposed on the outer surface of the substrate layer 10 according to the appearance requirement for products (see FIG. 2) for increasing the aesthetics of the products. The decorative layer 16 can be coated on the surface of the substrate layer 10 either through the gravure coating method or the extrusion coating method.

The sealing layer 15 located at the most inner side, which directly contacts with the electrolyte and the naked cell, is the first protective measurement for metal foil layer 12 as well as the last barrier for preventing the naked cell and the electrolyte from being impacted by the external environment. In this embodiment, the material of sealing layer 15 may be selected from polyethylene terephthalate, polyvinyl chloride, polyethylene, polypropylene, or the like, and the thickness of sealing layer 15 is better no less than 20 nm so as to avoid any influence on the pass ratio in the hot and humid test for the battery due to an over thin thickness.

The metal foil layer 12 and the anti-corrosion treatment layer 13 are located between the substrate layer 10 and the sealing layer 15, and are adhesively bonded the substrate layer 10 and the sealing layer 15 through the first bonding layer 11 and the second bonding layer 14. The normally used adhesive agent, preferably the polyurethanes glues resistant to the chemical medium, can be used for the first bonding layer 11 and the second bonding layer 14. For improving the adhesiveness of the anti-corrosion treatment layer 13, the surface toughening treatment can be performed to the anti-corrosion treatment layer 13. In this embodiment, the metal foil layer 12 can be a normal aluminum metal foil layer, or stainless steel materials such as the metal foil layers made of martensitic stainless steel, austenitic stainless steel and ferritic stainless steel. Although the stainless steel foil itself has comparatively excellent resistance to corrosion, it is not simply adapted in this embodiment, due to the increased difficulty of preparing it and its insufficient toughness and brittle fracture, which is not conducive to the production of the lithium-ion battery.

The anti-corrosion treatment layer 13 is specifically introduced below. In this embodiment, the anti-corrosion layer 13 can be composed of nickel layer or copper layer, or nickel alloy with the nickel as the main component or the copper alloy with the copper as the main component. The nickel alloy is selected from nickel-copper alloy, nickel-boron alloy, nickel-magnesium alloy, nickel-aluminum alloy, nickel-titanium alloy, nickel-vanadium alloy, nickel-iron alloy, nickel-manganese alloy, nickel-cobalt alloy, nickel-zinc alloy, nickel-silver alloy or a nickel-tin alloy. The copper alloy is selected from copper-nickel alloy, copper-boron alloy, copper-magnesium alloy, copper-aluminum alloy, copper-titanium alloy, copper-vanadium alloy, copper-iron alloy, copper-manganese alloy, copper-cobalt alloy, copper-zinc alloy, copper-silver alloy or copper-tin alloy.

Copper and nickel have higher resistance to the hydrofluoric acid, so chemical corrosion to the anti-corrosion layer is lighter even when the sealing layer 15 is damaged. Furthermore, if the copper plated layer is used, no initial battery reaction happens and on lithium precipitates on the copper surface when the short-circuit occurs to the anti-corrosion treatment layer 13 and the cathode, so the corrosion probability is greatly reduced.

Due to poor ductility and malleability, metals such as copper and nickel and alloys are not easily processed if they are independently used, so in this embodiment, the anti-corrosion treatment layer 13 is plated on the metal foil layer 12, which simplifies the treatment process of the anti-corrosion treatment layer 13, saves costs and reduced the battery weight.

The anti-corrosion treatment layer 13 can be obtained by treating the metals on the metal foil layer 12 through electroplating method or plating the metals through the heat spray or chemical plating method. Hence, any one of the methods has no influence to the implementation of the present disclosure.

In this embodiment, the anti-corrosion treatment layer 13 is either a signal layer or in a multiple-layer structure in which each layer has the same or different materials. The multiple-layer structure not only efficiently reduces the pitting corrosion caused by the micro particulates and film defects, but also improves the resistance to corrosion and the toughness of the packaging materials.

The bearable scour hole depth of the packaging bag embodies its machinable property, and the thickness of the metal layer is a major factor impacting the scour hole depth. When the sum of the thickness of the anti-corrosion treatment layer 13 and the thickness of the metal foil layer 12 reach to 20 μm, the scouring requirement is substantially satisfied. Meanwhile, after the anti-corrosion treatment layer 13 is plated on the surface of the metal foil layer 12, the scour hole depth of the lithium-ion battery will be impacted by the inconsistent ductility and malleability of the anti-corrosion treatment layer 13 and the metal foil layer 12 due to their different materials. Thus, in this embodiment, the anti-corrosion treatment layer 13 can not be over thick, and is better no larger than 50% of the thickness of the metal foil layer 12.

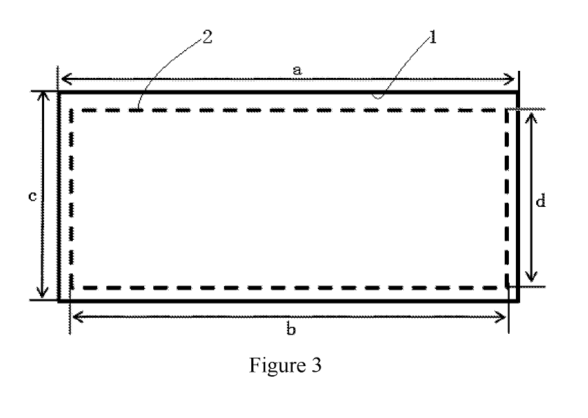

As shown in FIG. 3, embodiment two in this disclosure provides a lithium-ion battery comprising a packaging bag 1, a naked cell 2 and an electrolyte (no shown in drawings), wherein the packaging bag 1 made from the lithium-ion battery flexible packaging material provided in embodiment one, packages the naked cell 2 and the electrolyte together. In this embodiment, the dimension b of the naked cell 2 in the length direction is better to be close to the length dimension a of the packaging bag 1 as much as possible, and the dimension d of the naked cell 2 in the width direction is better to be close to the length dimension c of packaging bag 1 as much as possible, so as to keep the distance between the two dimensions within a small scope. Preferably, the dimension difference between the packaging bag 1 and the naked cell 2 in respective length direction and width direction is no more than 5 mm, such that the energy density of the lithium-ion battery is improved as much as possible.

The technical effects of the present disclosure are demonstrated in details as below through the experimental data.

1. Treatment to the Anti-Corrosion Treatment Layer on the Aluminum Metal Foil Layer

The anti-corrosion treatment layer can be obtained either by treating the metals on the aluminum metal foil layer through electroplating method or plating the metals through the heat spray or chemical plating method. Hence, any one of the methods has no influence to the implementation of the present disclosure.

2. Preparation of the Packaging Material

The preparation of the packaging material from the outer layer to inner layer comprises a substrate layer 10, a first bonding layer 11, a metal foil layer 12, an anti-corrosion treatment layer 13, a second bonding layer 14 and a sealing layer 15. The anti-corrosion treatment layer 13 is formed on the metal foil layer 12 through plating method. For improving the adhesiveness of the plating layer, the surface toughening treatment is performed to the metal plated layer, and the metal plating treatment to the metal foil layer and the preparation of the packaging bag are performed by common techniques without any specific limitations. The substrate layer 10 is selected from nylon, the adhesive agent is used for the bonding layer. The comparative examples and experimental examples of the packaging materials prepared according to different thickness and components of metal foil layer 12 and sealing layer 15 are respectively recorded as DP1-P10 and SDP1-SP10 as shown in table 1.

TABLE 1

| Packaging material No. | | | | | |
|---|---|---|---|---|---|
| | Foil | Aluminum | | | |
| | layer/ | foil/ | | | |
| | ferritic | stainless | Anti-corrosion | Total | Sealing |
| Foil | stainless | steel foil | treatment | thickness of | layer |
| layer/aluminum | steel foil | thickness | layer/thickness | metal layer | thickness |
| foil | (00Cr₃0Mo₂) | (μm) | (μm) | (μm) | (μm) |
| DP1 | SDP1 | 40 | 0 | 40 | 30 |
| DP2 | SDP2 | 10 | Copper layer/5 | 15 | 30 |
| DP3 | SDP3 | 15 | Copper layer/5 | 20 | 30 |
| DP4 | SDP4 | 35 | Copper layer/20 | 55 | 30 |
| DP5 | SDP5 | 40 | 0 | 40 | 80 |
| P1 | SP1 | 35 | Copper layer/5 | 40 | 40 |
| P2 | SP2 | 35 | Copper layer/5 | 40 | 15 |
| P3 | SP3 | 35 | Copper layer/5 | 40 | 50 |
| P4 | SP4 | 35 | Copper layer/5 | 40 | 60 |
| P5 | SP5 | 35 | Copper layer/5 | 40 | 20 |
| P6 | SP6 | 35 | Nickel layer/5 | 40 | 30 |
| P7 | SP7 | 35 | Nickel alloy | 40 | 30 |
| | | | (NiCu0.5)/5 | | |
| P8 | SP8 | 35 | Copper alloy | 45 | 30 |
| | | | (CuNi_{0.5})/10 | | |
| P9 | SP9 | 35 | Copper layer | 45 | 30 |
| | | | (inner layer) + | | |
| | | | Nickel layer | | |
| | | | (outer layer)/5 + 5 | | |
| P10 | SP10 | 35 | Nickel layer | 45 | 30 |
| | | | (inner layer) + | | |
| | | | Copper layer | | |
| | | | (outer layer)/5 + 5 | | |

3. Preparation of Lithium-Ion Battery
1) Preparation of Cathode Sheet

The cathode slurry is prepared by uniformly dispersing the cathode active material, the conductive carbon black Super-P as conductive agent, and the polyvinylidene fluoride (abbreviated as PVDF, the mass percentage of which in the adhesive agent is 10%) as the adhesive agent in the N-METHYL-2-PYRROLIDONE (abbreviated as NMP), wherein the anode slurry contains 75 wt % of solid contents, which corresponds to the solid components comprising 96 wt % of lithium cobalt oxides, 2 wt % of PVDF and 2 wt % of conductive carbon black Super-P. The cathode sheet is such obtained that the cathode slurry is uniformly coated on the aluminum foil as positive current collector in the thickness of 16 μm and an coating amount of 0.018 g/cm², then is cold pressed, side sheared, off-cut and stripped after being dried at 850, and finally is dried in vacuum condition for 4 hours at 850 and welded with lugs.

2) Preparation of Anode Sheet

The anode slurry is prepared by uniformly mixing the synthetic graphite being the anode active material, the conductive carbon black Super-P as conductive agent, sodium carboxy methyl cellulose (abbreviated as CMC, the mass percentage of which is 1.5%) as thickener, styrene butadiene rubber (abbreviated as SBR, mass percentage of which is 50%) as the adhesive agent in the deionized water. The anode slurry contains 50 wt % of solid contents, which corresponds to the solid components comprising 96.5 wt % of synthetic graphite, 1.0 wt % of conductive carbon black Super-P, 1.0 wt % of CMC and 1.5 wt % of SBR. The anode sheet is such obtained that the anode slurry is uniformly coated on the copper foil as negative current collector in the thickness of 12 μm and a coating amount of 0.0089 g/cm², then is cold pressed, side sheared, off-cut and stripped after being dried at 85□, and finally is dried in vacuum condition for 4 hours at 110□ and welded with lugs.

3) Preparation of Separator

The polypropylene film in thickness of 12 μm is used as a separator.

4) Preparation of Lithium-Ion Battery

The anode sheet, separator and the cathode sheet are laminated in sequence, such that the separator is located between the anode and cathode for separating them, and then are winded into a square naked cell in the thickness of 3 mm, width of 60 mm and length of 130 mm, the lithium-ion battery is prepared by the followings: the naked cell is put into the aluminum foil packaging bag, vacuum baked at 75□ for 10 hours, injected with electrolyte, vacuum enclosed and kept static for 24 hours; then it is charged with the constant currents of 0.1 C (160 mA) up to 4.4V, continuously charged at 4.4V of constant voltage until the currents decreases to 0.05 (80 mA) and after that discharged with constant currents of 0.1 C (160 mA); and it is charged and discharged as the previous process two more times and finally charged with the constant current of 0.1 C (160 mA) up to 3.8V, then the manufacture of the lithium-ion battery is completed.

The relations between the acquired lithium-ion battery numbers and the packaging material and the cell dimensions are listed in table 2.

TABLE 2

| | | | | Na- | | |
|---|---|---|---|---|---|---|
| | | Pack- | Naked | ked | Hole | Hole |
| Types of | | aging | cell | cell | length of | width of |
| metal foil | Battery | material | length | width | packaging | packaging |
| layers | No. | No. | (mm) | (mm) | bag (mm) | bag (mm) |
| Metal foil | DC1 | DP1 | 57 | 22 | 60 | 25 |
| layer/ | DC2 | DP2 | 57 | 22 | 60 | 25 |
| aluminum | DC3 | DP3 | 57 | 22 | 60 | 25 |
| foil | DC4 | DP4 | 57 | 22 | 60 | 25 |
| | DC5 | DP5 | 57 | 22 | 60 | 25 |
| | DC6 | DP1 | 54 | 19 | 60 | 25 |
| | C1 | P1 | 57 | 22 | 60 | 25 |
| | C2 | P2 | 57 | 22 | 60 | 25 |
| | C3 | P3 | 57 | 22 | 60 | 25 |
| | C4 | P4 | 57 | 22 | 60 | 25 |
| | C5 | P5 | 57 | 22 | 60 | 25 |
| | C6 | P6 | 57 | 22 | 60 | 25 |
| | C7 | P7 | 57 | 22 | 60 | 25 |
| | C8 | P7 | 57 | 22 | 60 | 25 |
| | C9 | P8 | 57 | 22 | 60 | 25 |
| | C10 | P9 | 57 | 22 | 60 | 25 |
| | C11 | P10 | 57 | 22 | 60 | 25 |
| | C12 | P5 | 57 | 20 | 60 | 25 |
| | C13 | P5 | 59 | 24 | 60 | 25 |
| | C14 | P5 | 55 | 22 | 60 | 25 |
| Metal foil | SDC1 | SDP1 | 57 | 22 | 60 | 25 |
| layer/ferritic | SDC2 | SDP2 | 57 | 22 | 60 | 25 |
| stainless | SDC3 | SDP3 | 57 | 22 | 60 | 25 |
| steel foil | SDC4 | SDP4 | 57 | 22 | 60 | 25 |
| (00Cr₃0Mo₂) | SDC5 | SDP5 | 57 | 22 | 60 | 25 |
| | SDC6 | SDP1 | 54 | 19 | 60 | 25 |
| | SC1 | SP1 | 57 | 22 | 60 | 25 |
| | SC2 | SP2 | 57 | 22 | 60 | 25 |
| | SC3 | SP3 | 57 | 22 | 60 | 25 |
| | SC4 | SP4 | 57 | 22 | 60 | 25 |
| | SC5 | SP5 | 57 | 22 | 60 | 25 |
| | SC6 | SP6 | 57 | 22 | 60 | 25 |
| | SC7 | SP7 | 57 | 22 | 60 | 25 |
| | SC8 | SP7 | 57 | 22 | 60 | 25 |
| | SC9 | SP8 | 57 | 22 | 60 | 25 |
| | SC10 | SP9 | 57 | 22 | 60 | 25 |
| | SC11 | SP10 | 57 | 22 | 60 | 25 |
| | SC12 | SP5 | 57 | 20 | 60 | 25 |
| | SC13 | SP5 | 59 | 24 | 60 | 25 |
| | SC14 | SP5 | 55 | 22 | 60 | 25 |

Tests are performed on each group of lithium-ion battery as below:

1. Tests on Anti-Permeability and Scour Hole Depth

Tests on anti-permeability: no layers are separated after 14 days' immersion in water at 60□, and the changes in weight are detected.

Maximum scour depth: it is formed by the module in work site and measured by calipers, and the maximum scour depth is a double-sided scour depth.

The test results are shown in table 3.

Through the anti-permeability test, all the packaging bags plated with the anti-corrosion treatment layers passes the permeability test. The bearable scour hole depth of the packaging bags embodies its machinable property and the thickness of the metal layer is a main factor influencing the scour hole depth. Through the comparison between DP2 and DP3, the metal layer in thickness of 15 μm is not beneficial for the scour hole depth, but when the sum thickness of the metal layers reaches 20 μm, the scour hole satisfies the requirements. As seen from DP4, different thicknesses of the metal layers influence the scour hole depth, when the anti-corrosion treatment layer 13 exceeds 50% of the thickness of the metal foil layer 12, it is not beneficial for the scour hole depth, mainly because of the inconsistence between the anti-corrosion treatment layer 13 and metal foil layer 12 in ductility and malleability, but it is still applicable for some thin cells. The stainless steel foil is weaker in scour hole depth as compared with the aluminum foil, which is mainly caused by the weak toughness of the stainless steel. The over thick sealing layer 15 is also not beneficial for scouring hole, due to the loss of energy density and cost waste caused by it, so normally a very thick sealing layer 15 is not choosed. As shown in experimental examples P1-P10, both the scour hole depth and permeability requirements are satisfied after the anti-corrosion treatment layer 13 is added.

TABLE 3

| | | |
|---|---|---|
| | Permeability, | Maximum |
| Packaging | changes | scour |
| material No. | in weight (g) | depth (mm) |

| \textcircled{1} | \textcircled{2} | \textcircled{1} | \textcircled{2} | \textcircled{1} | \textcircled{2} |
|---|---|---|---|---|---|
| DP1 | SDP1 | ~0.03 | ~0.03 | >7 | >4 |
| DP2 | SDP2 | ~0.03 | ~0.03 | 3.5 | >3 |
| DP3 | SDP3 | ~0.03 | ~0.03 | >7 | >4 |
| DP4 | SDP4 | ~0.03 | ~0.03 | 4.5 | >3 |
| DP5 | SDP5 | ~0.03 | ~0.03 | 6 | >3 |
| P1 | SP1 | ~0.03 | ~0.03 | >7 | >4 |
| P2 | SP2 | ~0.03 | ~0.03 | >7 | >4 |
| P3 | SP3 | ~0.03 | ~0.03 | >7 | >4 |
| P4 | SP4 | ~0.03 | ~0.03 | >7 | >4 |
| P5 | SP5 | ~0.03 | ~0.03 | >7 | >4 |
| P6 | SP6 | ~0.03 | ~0.03 | >7 | >4 |
| P7 | SP7 | ~0.03 | ~0.03 | >7 | >4 |
| P7 | SP7 | ~0.03 | ~0.03 | >7 | >4 |
| P8 | SP8 | ~0.03 | ~0.03 | >7 | >4 |
| P9 | SP9 | ~0.03 | ~0.03 | >7 | >4 |
| P10 | SP10 | ~0.03 | ~0.03 | >7 | >4 |

2. Tests on Corrosion Acceleration

An electronic channel is formed by connecting cathode lug of the fully charged lithium-ion battery with the metal conducting wire for packaging film in short-circuit, and the battery is stored in an environment with relative humidity >90% at 40-50□, and periodic tests on the battery shell are performed for detecting whether electrochemical corrosion occurs. During the high temperature and high humidity test, the environmental temperature for is 65-75□, and relative environmental humidity is 85-95%.

The test results are shown in table 4, wherein □ represents the data the batteries C1-C14 and DC1-DC6 correspond to, and □ represents the data the batteries SC1-SC14 and SDC1-SDC6 correspond to.

As shown in comparative examples DC1-DC6, in DC1, the aluminum foil has the thickness of 40 μm, the sealing layer has the thickness of 30 μm, the pass rate of the corrosion acceleration test is 10/100, and the pass rate of the heat and humidity test is ⅗; while in DC3, the aluminum foil has the thickness of 15 μm, and the copper as the anti-corrosion layer has the thickness of 5 μm, which passes the corrosion acceleration test and the high temperature and high humidity test. However, if in DC2, the aluminum foil having the thickness of 10 μm is added with an anti-corrosion of 5 μm, the corrosion problem will occur, which shows that the metal foil layer and the anti-corrosion layer resist the corrosion only when they reach to a certain thickness. According to the current technical levels, it is suggested to the thickness of the metal foil layer together with the anti-corrosion layer is larger than 20 μm. As shown in DC1 and DC5, the results of the corrosion test and t the high temperature and high humidity test can be improved by thickening the sealing layer from 30 μm to 80 μm, but it is not a good choice since it wastes cost and is not beneficial for the energy density of the cell. As shown in DC1 and DC6, the results of the corrosion test and the high temperature and high humidity test can also be improved by reducing the dimension of the naked cell instead of the packaging bag, namely enlarging the gap between the naked cell and the packaging bag. Due to the same principle for DC5, the energy density is also impacted by enlarging the physical distance to reduce the possibility of short-circuit between the naked cell and the packaging bag, and other problem may also by caused by the increased sliding between the cell and the packaging bag due to the enlarged gap. As shown in experimental examples C1-C14, the newly added metal anti-corrosion treatment layer can satisfy both the scour hole depth and the permeability requirements, but there is also requirement for the thickness of the sealing layer, for experimental example C2, the failure in the high temperature and high humidity test due to over thin sealing layer. When the aluminum foil is substituted with the stainless steel foil, the comparative examples SDC1-SDC6 and experimental examples SC1-SC14 are similar to the examples related to aluminum foil, so they are not repeatedly described herein.

TABLE 4

| | | |
|---|---|---|
| | Corrosion | |
| | Acceleration | |
| | Test (numbers | |
| | of corroded | High |
| | cells/total number | Temperature and |
| | for experiments | High Humidity |
| Cell No. | within two months) | (pass rate) |

| \textcircled{1} | \textcircled{2} | \textcircled{1} | \textcircled{2} | \textcircled{1} | \textcircled{2} |
|---|---|---|---|---|---|
| DC1 | SDC1 | 10/100 | 5/100 | 3/5 | 4/5 |
| DC2 | SDC2 | 12/100 | 8/100 | 3/5 | 3/5 |
| DC3 | SDC3 | 0/100 | 0/100 | 5/5 | 5/5 |
| DC4 | SDC4 | 0/100 | 0/100 | 5/5 | 5/5 |
| DC5 | SDC5 | 0/100 | 0/100 | 5/5 | 5/5 |
| DC6 | SDC6 | 0/100 | 0/100 | 5/5 | 5/5 |
| C1 | SC1 | 0/100 | 0/100 | 5/5 | 5/5 |
| C2 | SC2 | 0/100 | 0/100 | 3/5 | 4/5 |
| C3 | SC3 | 0/100 | 0/100 | 5/5 | 5/5 |
| C4 | SC4 | 0/100 | 0/100 | 5/5 | 5/5 |
| C5 | SC5 | 0/100 | 0/100 | 5/5 | 5/5 |
| C6 | SC6 | 0/100 | 0/100 | 5/5 | 5/5 |
| C7 | SC7 | 0/100 | 0/100 | 5/5 | 5/5 |
| C8 | SC8 | 0/100 | 0/100 | 5/5 | 5/5 |
| C9 | SC9 | 0/100 | 0/100 | 5/5 | 5/5 |
| C10 | SC10 | 0/100 | 0/100 | 5/5 | 5/5 |
| C11 | SC11 | 0/100 | 0/100 | 5/5 | 5/5 |
| C12 | SC12 | 0/100 | 0/100 | 5/5 | 5/5 |
| C13 | SC13 | 0/100 | 0/100 | 5/5 | 5/5 |
| C14 | SC14 | 0/100 | 0/100 | 5/5 | 5/5 |

In the present disclosure, through applying the flexible packaging material plated with the anti-corrosion treatment layer to the lithium-ion battery, the resistance to hydrofluoric acid is apparently improved, it is hard to form a lithium alloy, and no lithium precipitation occurs even if a short-circuit occurs to the anode and the packaging material, so the lithium-ion battery is capable of better resisting electrochemical corrosion, strengthening the safety, and prolonging the service life of the lithium-ion battery.

The foregoing are only preferred embodiments of the disclosure, and do not intend to limit the disclosure. Various modifications and changes can be made for those skilled in the art. Any variation, equivalent substitution and modification that fall within the spirit and principle of the present disclosure should be embraced by the protective scope of the present disclosure.

1. A lithium-ion battery flexible packaging material, comprising a substrate layer, a first bonding layer, a metal foil layer, an anti-corrosion treatment layer, a second bonding layer and a sealing layer arranged in sequence from the outside to the inside;
wherein the anti-corrosion treatment layer is composed of at least one of a nickel layer, a nickel alloy layer, a copper layer and a copper alloy layer, and is plated on the metal foil layer.

2. The lithium-ion battery flexible packaging material according to claim 1, wherein the anti-corrosion treatment layer is structured with multiple layers, material of each layer being the same or different.

3. The lithium-ion battery flexible packaging material according to claim 1, wherein the thickness of the anti-corrosion treatment layer does not exceed 50% of the thickness of the metal foil layer.

4. The lithium-ion battery flexible packaging material according to claim 1, wherein the sum of the thickness of the anti-corrosion treatment layer and the thickness of the metal foil layer is no less than 20 μm.

5. The lithium-ion battery flexible packaging material according to claim 1, wherein the material of the sealing layer is polyethylene terephthalate, polyvinyl chloride, polyethylene or polypropylene, and the thickness of the sealing layer is no less than 20 μm.

6. The lithium-ion battery flexible packaging material according to claim 1, wherein a decorative layer is provided on the outer side of the substrate layer.

7. The lithium-ion battery flexible packaging material according to claim 1, wherein,
the material of the nickel alloy layer is nickel-copper alloy, nickel-boron alloy, nickel-magnesium alloy, nickel-aluminum alloy, nickel-titanium alloy, nickel-vanadium alloy, nickel-iron alloy, nickel-manganese alloy, nickel-cobalt alloy, nickel-zinc alloy, nickel-silver alloy or a nickel-tin alloy; and/or
the material of the copper alloy layer is copper-nickel alloy, copper-boron alloy, copper-magnesium alloy, copper-aluminum alloy, copper-titanium alloy, copper-vanadium alloy, copper-iron alloy, copper-manganese alloy, copper-cobalt alloy, copper-zinc alloy, copper-silver alloy or copper-tin alloy.

8. The lithium-ion battery flexible packaging material according to claim 1, wherein the metal foil layer is a stainless steel metal foil layer.

9. A lithium-ion battery, comprising a naked cell, an electrolyte, and a packaging bag, wherein the packaging bag packages the naked cell and the electrolyte, wherein the packaging bag is made of the lithium-ion battery flexible packaging material according to claim 1.

10. The lithium-ion battery according to claim 9, wherein the difference between the dimension of the packaging bag in the length direction and the dimension of the naked cell in the same direction is no more than 5 mm; and/or
the difference between the dimension of the packaging bag in the width direction and the dimension of the naked cell in the same direction is no more than 5 mm.
